(19) United States
(12) Patent Application Publication
(10) Pub. No.: US 2022/0141199 A1
(43) Pub. Date: May 5, 2022

(54) METHOD AND SYSTEM FOR TRANSMITTING DATA IN A NETWORK

(71) Applicant: Siemens Aktiengesellschaft, München (DE)

(72) Inventors: Rainer Falk, Poing (DE); Kai Fischer, Baldham (DE); Steffen Fries, Baldham (DE); Andreas Furch, Freising (DE); Markus Heintel, München (DE); Niranjana Papagudi Subrahmanyam, Haar (DE); Tolga Sel, München (DE)

(21) Appl. No.: 17/431,162

(22) PCT Filed: Jan. 31, 2020
(86) PCT No.: PCT/EP2020/052420

§ 371 Date: Aug. 14, 2021

(30) Foreign Application Priority Data
Feb. 14, 2019 (EP) 19157151.2

(51) Int. Cl. H04L 9/40; H04L 43/0852; H04L 9/08

(52) U.S. Cl. CPC H04L 63/0428; H04L 9/0861; H04L 43/0858

(57) ABSTRACT

The proposal relates to a method for transmitting data in a network (NW) comprising a plurality M of communication apparatuses, with M≥2, wherein the plurality M comprises a first communication apparatus (20) and a second communication apparatus (30), which are connected via a network connection section (NVA) for the purpose of transmitting data, having the steps of: a) ascertaining a time-of-flight property of data transmitted between the first communication apparatus (20) and the second communication apparatus (30) via the network connection section (NVA) by means of the first communication apparatus (20) and the second communication apparatus (30) in each case, b) deriving a secret by means of the first communication apparatus (20) and the second communication apparatus (30) in each case, by using the respective ascertained time-of-flight property, and c) transmitting a message protected by means of the derived secret between the first and second communication apparatuses (20, 30). This method allows transmission of protected messages between two communication apparatuses.

This application is the National Stage of International Application No. PCT/EP2020/052420, filed Jan. 31, 2020, which claims the benefit of European Patent Application No. EP 19157151.2, filed Feb. 14, 2019. The entire contents of these documents are hereby incorporated herein by reference.

### BACKGROUND

The present embodiments relate to transmitting data in a network.

For the purpose of authenticating a first communication apparatus on a second communication apparatus and, for example, for the purpose of protecting communication connections for data transmission, either asymmetric, symmetric, or combined encryption methods are employed. By way of example, the authentication is carried out based on asymmetric key material and X.509 certificates.

If the communication apparatus to be authenticated, such as, for example, the first communication apparatus, is a device having very limited resources in terms of energy consumption, central processing unit (CPU) performance, and memory, it is not possible to perform asymmetric authentication within an acceptable period of time.

Devices having these constraints may often be found in Internet of Things (IoT) systems or in automation systems (e.g., sensors). In these cases, the authentication is, for example, carried out based on symmetric authentication protocols and shared symmetric keys.

In order to provide secure communication between the individual IoT devices of the system, the complexity for managing symmetric authentication protocols and symmetric keys for the respective individual IoT devices increases with the number of IoT devices (e.g., communication apparatuses) involved, however.

WO 2006/081122 A2 discloses a method and a system for deriving a key for encryption using a joint randomness not shared by others (JRNSO). Communication units generate JRNSO bits from a channel impulse response (CIR) estimate, and the JRNSO bits are used to generate a key for encryption. The authentication type may be an IEEE 802.1x system or a pre-installed key system. In an IEEE 802.1x system, the JRNSO bits may be used to generate a master key, a paired master key, or a paired transient key. The key for encryption may be generated by using a Diffie-Hellman key derivation algorithm.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, transmission of data in a network is improved.

According to a first aspect, a method for transmitting data in a network including a plurality M of communication apparatuses, with M≥2, is provided. The plurality M of communication apparatuses includes a first communication apparatus and a second communication apparatus that are connected via a network connection section for the purpose of transmitting data. The method includes ascertaining, by each of the first communication apparatus and the second communication apparatus, a time-of-flight property of data transmitted between the first communication apparatus and the second communication apparatus via the network connection section. The first communication apparatus and the second communication apparatus each derive a secret by using the respective ascertained time-of-flight property. A message protected by the derived secret is transmitted between the first communication apparatus and the second communication apparatus.

In the present method, the first act involves a respective time-of-flight property of data transmitted between the first communication apparatus and the second communication apparatus via the network connection section being ascertained.

The respective ascertained time-of-flight property is then used in the second act to derive a respective identical secret. Subsequently, it is possible in the third act to protect the messages to be transmitted using the identical derived secret.

This has the technical effect that the first communication apparatus and the second communication apparatus may individually derive a shared (e.g., identical) secret from the respective ascertained time-of-flight property without previously having had a protected communication relationship or previously having exchanged a secret.

This has the advantage that security for the transmission of messages is increased, while the technical complexity for providing this security is reduced. Further, the present method hampers a “man-in-the-middle attack”. Another advantage is that the present method requires no input from a user and may be performed in automated fashion.

The transmission of protected messages between the first communication apparatus and the second communication apparatus is only set up successfully if the ascertained time-of-flight properties of both the first communication apparatus and the second communication apparatus are the same.

The network, for example, includes a third, a fourth or a further communication apparatus. The network may also be a communication network or a computer network. In one embodiment, the network is a device or an infrastructure in which at least a first communication apparatus and a second communication apparatus interchange data or information. This is accomplished, for example, by virtue of the network connection section being provided between the first communication apparatus and the second communication apparatus.

The communication apparatus may be an apparatus configured to communicate and interchange data with another communication apparatus. The communication apparatus is, for example, a device that has an interface for a communication setup, a communication connection, and a communication data interchange with another device. For example, the communication apparatus is an embedded device.

The network connection section may be a communication channel, a channel, an information channel, a transmission channel, or a transmission path for transmitting data between at least the first communication apparatus and the second communication apparatus. By way of example, multiple network connection sections are arranged in succession and/or in parallel with one another between the first communication apparatus and the second communication apparatus.

The time-of-flight property is, for example, a network property of a network protocol. To classify and structure the network protocol, such as, for example, Transmission Control Protocol (TCP), User Data Protocol (UDP), Transport Layer Security Protocol (TLS), Datagram Transport Layer Security (DTLS), and/or Hypertext Transfer Protocol (HTTP), the ISO/OSI layer model may be used. For example, the network property of a network protocol in layer 2 (e.g., data link layer), in layer 3 (e.g., network layer), or in layer 4 (e.g., transport layer) is ascertained. Network properties of a network protocol from layers 5 to 7 of the ISO/OSI layer model or the Message Queueing Telemetry Transport (MQTT) protocol used for machine-to-machine communication may also be ascertained. The time-of-flight property may be different for a specific network connection section for different network protocols.

The secret is, for example, a cryptographic key and in this case may be a symmetric cryptographic key. The secret may be used for protecting the communication (e.g., for encrypted and/or integrity-protected or authenticated message transmission between the first communication apparatus and the second communication apparatus). This provides that the symmetric key may be used by the first communication apparatus and the second communication apparatus of the network for encrypting and decrypting and/or for protecting an integrity or an authenticity of messages. The secret is, for example, identical for the first communication apparatus and the second communication apparatus. The secret may also be referred to as a shared derived secret.

The protected message may be a protected message including control data and/or monitoring data that is transmitted from the first communication apparatus to the second communication apparatus, or vice versa, in the network in a protected manner. Additionally, a message is, for example, understood in the present case to be a digital dataset (e.g., a series of zeros and ones, also referred to as bits, having a specific length).

For example, the ascertained time-of-flight property for the ascertainment in act a) is in the form of a mean value, in the form of a temporal characteristic, and/or in the form of an extreme value.

In one embodiment, act b) involves the first communication apparatus and the second communication apparatus each deriving a secret by using the respective ascertained time-of-flight property of the first communication apparatus and the second communication apparatus.

The message is cryptographically protected and then transmitted, for example. A cryptographically protected message may, for example, be the protection of the confidentiality and/or the protection of the authenticity or the integrity of the message and/or parts of the message. The cryptographic protection may be realized by the derived secret and by a security protocol, such as, for example, TLS, Secure Socket Layer (SSL), Secure Shell (SSH), and/or Internet Protocol Security (IPSec).

In one embodiment, the transmission of protected messages between the first communication apparatus and the second communication apparatus is performed bidirectionally or unidirectionally.

According to the first aspect, the network connection section is in the form of a wired network connection section or in the form of an optical network connection section.

A wired network connection section may, for example, be a network connection section for which the medium for transmitting data is formed from metallic materials, such as, for example, copper or aluminum.

An optical network connection section may, for example, be a network connection section for which the medium for transmitting the data is light. For example, optical waveguides and fiber-optics cables formed from optical fibers are used in this case.

Additionally, in one embodiment, in a case in which multiple network connection sections are connected between the first communication apparatus and the second communication apparatus in succession, at least one network connection section may be in wired form and at least one other network connection section may be in optical form. It is also possible for multiple network connection sections in succession to each be in wired form or to each be in optical form.

According to another embodiment, the time-of-flight property is ascertained at a time of a connection setup between the first communication apparatus and the second communication apparatus.

The time of the connection setup is, for example, also referred to as a time of an initialization of a communication connection between the first communication apparatus and the second communication apparatus.

In one embodiment, guidelines (e.g., policies) for determining the time-of-flight property between the first communication apparatus and the second communication apparatus are dynamically negotiated during connection setup.

According to another embodiment, the second act involves the secret being derived by both the first communication apparatus and the second communication apparatus using a key derivation function that uses a number of derivation parameters. The derivation parameters include at least the respective ascertained time-of-flight property.

Additionally, the respective derivation of the secret may be linked to a specific condition. This may involve a secret being derived, for example, by Diffie-Hellman key exchange, only if the respective ascertained time-of-flight property is below or above a specific threshold value.

According to another embodiment, the derivation parameters also include respective previously configured data and/or respective dynamic data.

The dynamic data is, for example, interchanged with one another during the connection setup between the first communication apparatus and the second communication apparatus and may then be used as derivation parameters.

According to another embodiment, the respective ascertained time-of-flight property includes a first piece of time information and a second piece of time information, where a concatenation of the first time information and the second time information, a difference between the first time information and the second time information, specific data of the first time information and the second time information, or key bits generated based on the first time information and the second time information are used as the derivation parameters in the key derivation function.

The first time information is, for example, a master clock of the first communication apparatus and/or the second communication apparatus, while the second time information may be a slave clock of the first communication apparatus and/or the second communication apparatus. The first time information and the second time information are, for example, each a time, such as a specific clock time on one communication apparatus and/or a time transmitted from the first communication apparatus to the second communication apparatus, or vice versa.

The specific data of the first time information and the second time information may be specific parts that are scarcely predictable, such as, for example, ms components (millisecond components) of the first time information and the second time information.

According to another embodiment, the previously configured data is in the form of fixed labels, in the form of master keys, and/or in the form of other previously configured derivation information.

According to another embodiment, the dynamic data is in the form of device addresses, in the form of nonces, and/or in the form of checksums of messages exchanged via the network connection section.

According to another embodiment, the second act involves the secret being generated by both the first communication apparatus and the second communication apparatus using a key generation function that uses a number of key generation parameters. The key generation parameters include at least the respective ascertained time-of-flight property.

According to another embodiment, a time-of-flight property of data transmitted between the first communication apparatus and the second communication apparatus via the respective redundant network connection section from the plurality N of redundant network sections is ascertained by the first communication apparatus and the second communication apparatus for each redundant network connection section of a plurality N of redundant network connection sections between the first communication apparatus and the second communication apparatus, with N≥2, where the respective ascertained time-of-flight property is used as part of the derivation parameters in the key derivation function.

According to another embodiment, multiple time-of-flight properties of data transmitted between the first communication apparatus and the second communication apparatus via the respective redundant network connection section from the plurality N of redundant network sections are ascertained by the first communication apparatus and the second communication apparatus for each redundant network connection section of the plurality N of redundant network connection sections between the first communication apparatus and the second communication apparatus. The respective ascertained multiple time-of-flight properties are used as part of the derivation parameters in the key derivation function.

For example, redundant network connection sections are formed in time-sensitive environments, such as according to a TSN IEEE 802.1Q standard. In this case, the first communication apparatus and the second communication apparatus may be used to ascertain multiple time-of-flight properties of data transmitted between the first communication apparatus and the second communication apparatus via a redundant network connection section that are used as derivation parameters in the key derivation function.

This has the advantage that network components of exclusively the first communication apparatus and the second communication apparatus in the network may observe only one network connection section of the transmitted messages and therefore do not know the full set of derivation parameters for the key derivation function.

According to another embodiment, the respective ascertained time-of-flight property is in the form of a latency.

A latency may, for example, be a transmission time for a data packet during transmission between the first communication apparatus and the second communication apparatus.

In this embodiment, the respective latency of data transmitted between the first communication apparatus and the second communication apparatus via the network connection section is, for example, ascertained and used as a derivation parameter in the key derivation function. The latency may be referred to as delay or as network latency.

In order to ascertain the latency, each of the first communication apparatus and the second communication apparatus includes a component by which it is possible to determine the latency to the respective other communication apparatus. This has the advantage that an attacker is prevented from being able to infer the ascertained latency from the transmitted data.

In order to ascertain the latency (e.g., time-of-flight property) of transmitted data between the first communication apparatus and the second communication apparatus, a time synchronization protocol, such as the Precision Time Protocol (PTP), is, for example, used.

In this case, the first communication apparatus and the second communication apparatus have a PTP Master Clock function and a PTP Slave Clock function. Two communication apparatuses, such as the first communication apparatus and the second communication apparatus, wanting to derive a shared symmetric cryptographic key with one another do so by each stipulating a local time during connection setup. The local time may be being chosen at random and may be valid only for the key derivation or key generation.

In a further act, in each case, for example, the slave clock of one communication apparatus (e.g., the first communication apparatus) synchronizes itself to the time of the master clock of the other communication apparatus (e.g., the second communication apparatus) by determining the latency.

This synchronization may involve the difference between the local times (e.g., the difference between the respective master clocks of the first communication apparatus and the second communication apparatus) and the latency of the network being used. A possible attacker on the network connection section between the first communication apparatus and the second communication apparatus may not simply be able to concomitantly read or calculate the latency of the network.

Following successful synchronization, the first communication apparatus and the second communication apparatus, for example, have two pieces of time information (e.g., respective own locally stipulated time (the first time information, the master clock) and the synchronized time of the respective other communication apparatus (the second time information, the slave clock)).

Subsequently, for example, the time information is used to derive a shared symmetric cryptographic key that is then subsequently used to protect messages transmitted between the first communication apparatus and the second communication apparatus. For example, a new local time is stipulated as a base time for every connection setup to a further communication apparatus.

The first time information may be a master clock of the first communication apparatus and/or the second communication apparatus, while the second time information is a slave clock of the first communication apparatus and/or the second communication apparatus.

When multiple, redundant network connection sections are used, the synchronization of the master and slave clocks may be performed separately for each network connection section, and, for example, all synchronized time information of the individual network connection sections of the multiple redundant network connection sections may be used in the key derivation function as derivation parameters.

Additionally, the ascertained time-of-flight property may be in the form of a throughput or jitter.

The throughput may be a number of bits that are transmitted in a network connection section between the first communication apparatus and the second communication apparatus per stipulated unit of time.

Jitter may, for example, be an interval of time for an arrival of data packets or a regularity for the arrival of data packets during the transmission of data packets between the first communication apparatus and the second communication apparatus via the network connection section.

According to another embodiment, the latency for the transmission of a message between the first communication apparatus and the second communication apparatus is manipulated by using a device arranged in the first communication apparatus and/or the second communication apparatus.

In this case, the two communication apparatuses, for example, each have a further component by which the latency for the transmission and/or reception of the transmitted messages is influenced or manipulated. The influencing or manipulation includes, for example, a deterministic delaying for the transmission of messages.

According to another embodiment, the ascertainment of the latency involves both the first communication apparatus and the second communication apparatus generating the latency of the network connection section between the first communication apparatus and the second communication apparatus specifically for the network connection section using a generator.

In one embodiment, the network includes a further component that is in the form of a network generator. The network generator is, for example, configured to generate at least a latency between the first communication apparatus and the second communication apparatus specifically for the network connection section. The network generator may be in the form of a part of a switch or of a router.

According to another embodiment, the first communication apparatus, for example, confirms the time-of-flight property ascertained by the first communication apparatus to the second communication apparatus in cryptographically encrypted fashion.

Cryptographically encrypted confirmation, for example, includes cryptographically encrypted confirmation using a session key that is set up in unauthenticated or unilaterally authenticated fashion within the context of a session. In one embodiment, the second communication apparatus subsequently checks the time-of-flight property ascertained and confirmed by the first communication apparatus for consistency with the time-of-flight property that the second communication apparatus has ascertained itself. This may, for example, be carried out unilaterally or bilaterally.

According to another embodiment, a calculated checksum of the messages transmitted within the context of the session is included in the confirmation too.

The checksum is, for example, formed locally at the first communication apparatus and the second communication apparatus by hashing the message that is to be transmitted and/or to be received. In one embodiment, the calculated checksum is used to form a hash chain. Additionally, the calculated checksum may, for example, either explicitly be contained in the confirmation or used for cryptographically encrypting the confirmation, such as by a keyed-Hash Message Authentication Code (HMAC).

According to another embodiment, instead of the locally stipulated time, only the measured latency between the first communication apparatus and the second communication apparatus is ascertained. This is carried out by Internet Control Message Protocol (ICMP) Ping, for example.

According to a second aspect, a computer program product that instigates the performance of the method as explained above on a program-controlled device is provided.

A computer program product, such as, for example, a computer program means, may, for example, be provided or delivered as a storage medium (e.g., a non-transitory computer-readable storage medium), such as, for example, memory card, USB stick, CD-ROM, DVD, or else in the form of a downloadable file from a server in a network. This may, for example, be carried out in a wireless communication network by transmitting an appropriate file containing the computer program product or the computer program means.

According to a third aspect, a system for transmitting data in a network includes a plurality M of communication apparatuses, with M≥2, where the plurality M of communication apparatuses includes a first communication apparatus and a second communication apparatus that are connected via a network connection section for the purpose of transmitting data. Each of the first communication apparatus and the second communication apparatus includes: an ascertainment unit for ascertaining a time-of-flight property of data transmitted between the first communication apparatus and the second communication apparatus via the network connection section, a derivation unit (e.g., one or more processors) for deriving a secret by using the respective ascertained time-of-flight property, and a transmission unit (e.g., a transmitter) for transmitting a message protected by the derived secret between the first and the second communication apparatus.

The respective unit (e.g., the ascertainment unit or the derivation unit) may be implemented in hardware and/or in software. When implemented in hardware, the respective unit may be in the form of an apparatus or in the form of part of an apparatus (e.g., in the form of a computer, a microprocessor, or a control computer of a vehicle). When implemented in software, the respective unit may be in the form of a computer program product, in the form of a function, in the form of a routine, in the form of part of a program code, or in the form of an executable object.

The embodiments and features described for the proposed method apply to the proposed system accordingly.

Further possible implementations of the present embodiments also include combinations, not explicitly mentioned, of features or embodiments described above or below with regard to the exemplary embodiments. In this case, a person skilled in the art will also add individual aspects as improvements or supplementations with regard to the respective basic form of the invention.

### BRIEF DESCRIPTION OF THE DRAWINGS

FIG. 1 shows a schematic flowchart for a first exemplary embodiment of a method for transmitting data in a network;

FIG. 2 shows a schematic flowchart for a second exemplary embodiment of a method for transmitting data in a network; and

FIG. 3 shows a schematic block diagram of an exemplary embodiment of a system for transmitting data in a network.

Elements that are the same or that have the same function have been provided with the same reference signs in the figures, unless indicated otherwise.

### DETAILED DESCRIPTION

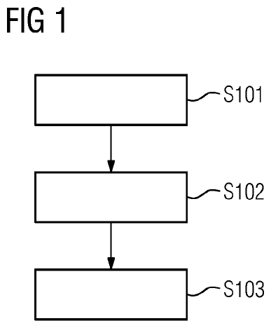

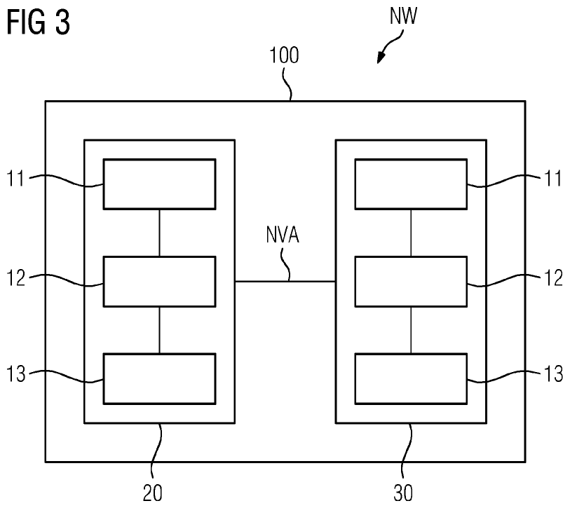

FIG. 1 shows a schematic flowchart for a first exemplary embodiment of a method for transmitting data in a network NW, as depicted, for example, in FIG. 3. The network NW includes a plurality M of communication apparatuses, with M≥2. The plurality M of communication apparatuses includes a first communication apparatus 20 and a second communication apparatus 30 that are connected via a network connection section NVA of the network NW for the purpose of transmitting data.

The first exemplary embodiment in FIG. 1 includes method acts S101, S102 and S103.

In a first act S101, a time-of-flight property of data transmitted between the first communication apparatus 20 and the second communication apparatus 30 via the network connection section NVA is ascertained. The ascertainment is carried out by both the first communication apparatus 20 and the second communication apparatus 30. The network connection section NVA is, for example, wired or optical in this case.

Moreover, the time-of-flight property is ascertained in the first act S101 at a time, for example, when a connection between the first communication apparatus 20 and the second communication apparatus 30 is set up.

In a subsequent act S102, a secret is derived by both the first communication apparatus 20 and the second communication apparatus 30 by using the respective ascertained time-of-flight property.

The respective secret is, for example, derived by a key derivation function that uses a number of derivation parameters. In this case, the number of derivation parameters includes at least the respective ascertained time-of-flight property.

The derivation parameters also includes, for example, previously configured data, such as, for example, fixed labels, master keys, or other previously configured derivation information.

Additionally, the derivation parameters may include dynamic data, such as, for example, device addresses, nonces, or checksums from messages exchanged via the network connection section NVA.

In another case, the respective secret may be generated by the first communication apparatus 20 and the second communication apparatus 30 using a key generation function that uses a number of key generation parameters. The number of key generation parameters include at least the respective ascertained time-of-flight property.

By way of example, a plurality N of redundant network connection sections, with N≥2, is arranged between the first communication apparatus 20 and the second communication apparatus 30.

A time-of-flight property of data transmitted between the first communication apparatus 20 and the second communication apparatus 30 via the respective redundant network connection section may be ascertained for each redundant network connection section of the plurality N of redundant network connection sections.

For example, it is possible to ascertain multiple time-of-flight properties of data transmitted between the first communication apparatus 20 and the second communication apparatus 30 via the respective redundant network connection section for each redundant network connection section of the plurality N of redundant network connection sections.

This ascertainment is, for example, carried out by both the first communication apparatus 20 and the second communication apparatus 30. Additionally, the respective ascertained time-of-flight property or the respective ascertained time-of-flight properties is or are used as part of the derivation parameters in the key derivation function.

In a final act S103, a message protected by the derived secret is transmitted between the first communication apparatus 20 and the second communication apparatus 30.

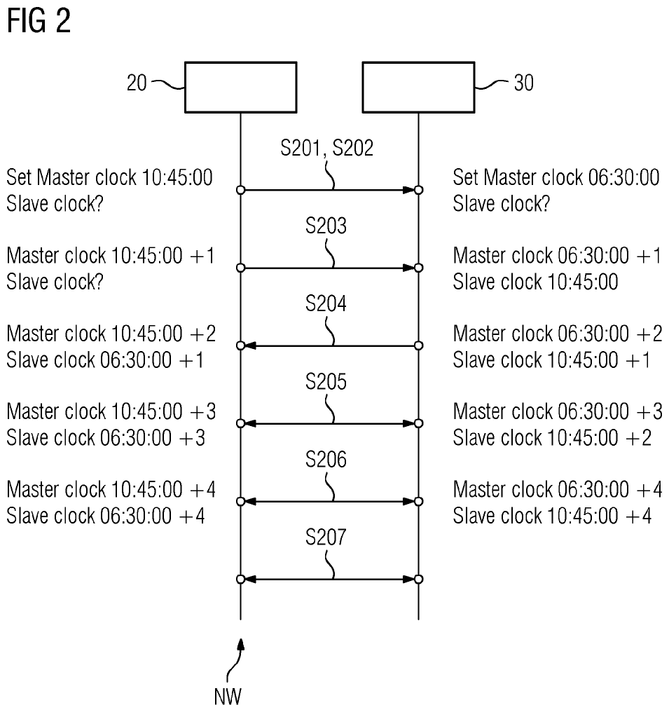

FIG. 2 shows a schematic flowchart for a second exemplary embodiment of a method for transmitting data in a network NW. The network NW includes a first communication apparatus 20 and a second communication apparatus 30 between which messages, some of which are protected, are transmitted.

In the flowchart in FIG. 2, the respective ascertained time-of-flight property is, for example, a latency.

The first exemplary embodiment in FIG. 2 includes method acts S201 to S207. In method acts S201 to S207 that follow, first, the synchronization process by the time synchronization protocol PTP and also the subsequent transmission of protected messages may be described. Additionally, for the purpose of better understanding, it is assumed that the time advances by one second with every depicted message exchange. This is, for example, depicted in each step by the second values +1, +2, +3 and +4 for the first communication apparatus 20 and the second communication apparatus 30 in FIG. 2.

In a first act S201, the first communication apparatus 20 starts a connection setup to the second communication apparatus 30.

In act S202, each of the first communication apparatus 20 and the second communication apparatus 30 selects a random starting value for a respective master clock. The first communication apparatus 20 selects the time 10:45:00, while the second communication apparatus 30 selects the time 06:30:00. The master clock is, for example, a first piece of time information of the first communication apparatus 20 and the second communication apparatus 30, while the slave clock may be a second piece of time information of the first communication apparatus 20 and the second communication apparatus 30.

In act S203, the first communication apparatus 20 transmits the respective master clock to the second communication apparatus 30. The master clock of the first communication apparatus 20 now becomes the slave clock of the second communication apparatus 30.

In act S204, the second communication apparatus 30 transmits the respective master clock to the first communication apparatus 20. In this case, the master clock of the second communication apparatus 30 now becomes the slave clock of the first communication apparatus 20.

In act S205, the first communication apparatus 20 synchronizes the slave clock of the first communication apparatus 20 to the master clock of the second communication apparatus 30 by ascertaining the latency between the first communication apparatus 20 and the second communication apparatus 30 via the network connection section NVA.

In act S206, the second communication apparatus 30 synchronizes the slave clock of the second communication apparatus 30 to the master clock of the first communication apparatus 20 by ascertaining the latency between the first communication apparatus 20 and the second communication apparatus 30 via the network connection section NVA.

Subsequently, the first communication apparatus 20 and the second communication apparatus 30 have corresponding master and slave clocks in sync. It is therefore possible, on the basis of the ascertained synchronous first time information and second time information or other derivation parameters, to derive the respective secret using the key derivation.

Further, other derivation parameters that may be used in the key derivation function are a concatenation of the first time information and the second time information or a difference between the first time information and the second time information.

Additionally, specific data of the first time information and the second time information or key bits generated on the basis of the first time information and the second time information may be used as the other derivation parameters in the key derivation function.

Subsequently, it is possible in act S207 to transmit protected messages between the first communication apparatus 20 and the second communication apparatus 30 via at least the network connection section NVA.

In one embodiment, the latency for the transmission of a message between the first communication apparatus 20 and the second communication apparatus 30 is manipulated by using a device. The device is, for example, arranged in the first communication apparatus 20 and/or the second communication apparatus 30.

For example, the ascertainment of the latency involves both the first communication apparatus 20 and the second communication apparatus 30 generating the latency of the network connection section NVA between the first communication apparatus 20 and the second communication apparatus 30 using a generator. The latency of the network connection section NVA is, for example, specific to the network connection section NVA.

FIG. 3 shows a schematic block diagram of an exemplary embodiment of a system 100 for transmitting data in a network NW. The system 100 includes a plurality M of communication apparatuses 20, 30, with M≥2, where the plurality M includes a first communication apparatus 20 and a second communication apparatus 30 that are connected via a network connection section NVA for the purpose of transmitting data.

Each of the first communication apparatus 20 and the second communication apparatus 30 has, for example, an ascertainment unit 11, a derivation unit 12, and a transmission unit 13.

The ascertainment unit may be configured to ascertain a time-of-flight property of data transmitted between the first communication apparatus 20 and the second communication apparatus 30 via the network connection section NVA.

For example, the derivation unit 12 is configured to derive a secret by using the respective ascertained time-of-flight property.

The transmission unit 13 is configured to transmit a message protected by the derived secret between the first communication apparatus 20 and the second communication apparatus 30.

Although the present embodiments have been described based on exemplary embodiments, the present embodiments are modifiable in a wide variety of ways.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for transmitting data in a network comprising two or more communication apparatuses, the two or more communication apparatuses comprising a first communication apparatus and a second communication apparatus that are connected via a network connection section for the purpose of transmitting data, the method comprising:
ascertaining, by each of the first communication apparatus and the second communication apparatus, a respective time-of-flight property of data transmitted between the first communication apparatus and the second communication apparatus via the network connection section, wherein the network connection section is in the form of a wired network connection section or in the form of an optical network connection section;
deriving, by each of the first communication apparatus and the second communication apparatus, a secret by using the respective ascertained time-of-flight property; and
transmitting a message protected by the derived secret between the first and the second communication apparatus.

2. The method of claim 1, wherein the time-of-flight property is ascertained at a time of a connection setup between the first communication apparatus and the second communication apparatus.

3. The method of claim 1, wherein deriving the secret comprises deriving the secret by both the first communication apparatus and the second communication apparatus using a key derivation function that uses a number of derivation parameters, the number of derivation parameters comprising at least the respective ascertained time-of-flight property.

4. The method of claim 3, wherein the derivation parameters further comprise respective previously configured data, respective dynamic data, or a combination thereof.

5. The method of claim 3, wherein the respective ascertained time-of-flight property comprises a first piece of time information and a second piece of time information, and
wherein a concatenation of the first piece of time information and the second piece of time information, a difference between the first piece of time information and the second piece of time information, specific data of the first piece of time information and the second piece of time information, or key bits generated based on the first piece of time information and the second piece of time information are used as the derivation parameters in the key derivation function.

6. The method of claim 4, wherein the previously configured data is in the form of fixed labels, in the form of master keys, in the form of other previously configured derivation information, or in the form of any combination thereof.

7. The method as claimed in one of claims 4 to 6, wherein the dynamic data is in the form of device addresses, nonces, checksums of messages exchanged via the network connection section, or any combination thereof.

8. The method of claim 1, wherein deriving the secret comprises generating the secret by both the first communication apparatus and the second communication apparatus using a key generation function that uses a number of key generation parameters, the key generation parameters comprising at least the respective ascertained time-of-flight property.

9. The method of claim 3, wherein:
a time-of-flight property of data transmitted between the first communication apparatus and the second communication apparatus via a respective redundant network connection section from a plurality of redundant network sections is ascertained by the first communication apparatus and the second communication apparatus for each redundant network connection of the plurality of redundant network connection sections between the first communication apparatus and the second communication apparatus, wherein the respective ascertained time-of-flight property is used as part of the derivation parameters in the key derivation function;
multiple time-of-flight properties of data transmitted between the first communication apparatus and the second communication apparatus via the respective redundant network connection section from the plurality of redundant network sections are ascertained by the first communication apparatus and the second communication apparatus for each redundant network connection section of the plurality of redundant network connection sections between the first communication apparatus and the second communication apparatus, wherein the respective ascertained multiple time-of-flight properties are used as part of the derivation parameters in the key derivation function; or
a combination thereof.

10. The method of claim 1, wherein the respective ascertained time-of-flight property is in the form of a latency.

11. The method of claim 10, wherein the latency for the transmission of a message between the first communication apparatus and the second communication apparatus is manipulated by using a device arranged in the first communication apparatus, the second communication apparatus, or the first communication apparatus and the second communication apparatus.

12. The method of claim 10, wherein ascertainment of the latency comprises both the first communication apparatus and the second communication apparatus generating the latency of the network connection section between the first communication apparatus and the second communication apparatus specifically for the network connection section by a generator.

13. (canceled)

14. A system for transmitting data in a network, the system comprising:
a plurality of communication apparatuses, wherein the plurality of communication apparatuses comprises a first communication apparatus and a second communication apparatus that are connected via a network connection section for the purpose of transmitting data, wherein each of the first communication apparatus and the second communication apparatus comprises:
an ascertainment unit configured to ascertain a time-of-flight property of data transmitted between the first communication apparatus and the second communication apparatus via the network connection section, the network connection section being in the form of a wired network connection section or in the form of an optical network connection section;
a derivation unit configured to derive a secret by using the respective ascertained time-of-flight property; and
a transmission unit configured to transmit a message protected by the derived secret between the first communication apparatus and the second communication apparatus.

15. In a non-transitory computer-readable storage medium that stores instructions executable by one or more processors to transmit data in a network comprising two or more communication apparatuses, the two or more communication apparatuses comprising a first communication apparatus and a second communication apparatus that are connected via a network connection section for the purpose of transmitting data, the instructions comprising:
ascertaining, by each of the first communication apparatus and the second communication apparatus, a respective time-of-flight property of data transmitted between the first communication apparatus and the second communication apparatus via the network connection section, wherein the network connection section is in the form of a wired network connection section or in the form of an optical network connection section;
deriving, by each of the first communication apparatus and the second communication apparatus, a secret by using the respective ascertained time-of-flight property; and
transmitting a message protected by the derived secret between the first and the second communication apparatus.

16. The non-transitory computer-readable storage medium of claim 15, wherein the time-of-flight property is ascertained at a time of a connection setup between the first communication apparatus and the second communication apparatus.

17. The non-transitory computer-readable storage medium of claim 15, wherein deriving the secret comprises deriving the secret by both the first communication apparatus and the second communication apparatus using a key derivation function that uses a number of derivation parameters, the number of derivation parameters comprising at least the respective ascertained time-of-flight property.

18. The non-transitory computer-readable storage medium of claim 17, wherein the derivation parameters further comprise respective previously configured data, respective dynamic data, or a combination thereof.

19. The non-transitory computer-readable storage medium of claim 17, wherein the respective ascertained time-of-flight property comprises a first piece of time information and a second piece of time information, and
wherein a concatenation of the first piece of time information and the second piece of time information, a difference between the first piece of time information and the second piece of time information, specific data of the first piece of time information and the second piece of time information, or key bits generated based on the first piece of time information and the second piece of time information are used as the derivation parameters in the key derivation function.

20. The non-transitory computer-readable storage medium of claim 18, wherein the previously configured data is in the form of fixed labels, in the form of master keys, in the form of other previously configured derivation information, or in the form of any combination thereof.
